(19) United States
(12) Patent Application Publication
(10) Pub. No.: US 2010/0088180 A1
(43) Pub. Date: Apr. 8, 2010

(54) Online Word-of-Mouth Marketing of a Web Service Using Personalized Invitations via a Status Messaging Service

(75) Inventors: Maximilian A. Ventilla, San Francisco, CA (US); Damon M. Horowitz, New York, NY (US); Robert J. Spiro, San Francisco, CA (US); Dan D. Addison, Pasadena, CA (US)

Correspondence Address: FENWICK & WEST LLP, SILICON VALLEY CENTER, 801 CALIFORNIA STREET, MOUNTAIN VIEW, CA, 94041, US

(73) Assignee: THE MECHANICAL ZOO, INC., San Francisco, CA (US)

(21) Appl. No.: 12/471,368

(22) Filed: May 23, 2009

Related U.S. Application Data
(60) Provisional application No. 61/128,731, filed on May 23, 2008.

(51) Int. Cl. G06Q 30/00; G06Q 50/00; G06F 15/16

(52) U.S. Cl. 705/14.53; 705/14.73; 709/206

(57) ABSTRACT

A status messaging service is used as an online channel for indirect messaging in a word-of-mouth marketing campaign. A user of a web service is prompted to endorse the web service to the user's friends or other connections by submitting a status message to one or more status messaging services to which the user belongs. The status message contains an endorsement of the web service and may further contain a link to a personal invitation page for the web service. By submitting the status message to a status messaging service, the endorsement contained therein is then communicated to the user's connections in the status messaging service.

### CROSS REFERENCE TO RELATED APPLICATIONS

This application claims the benefit of U.S. Provisional Application No. 61/128,731, filed May 23, 2008, which is incorporated by reference in its entirety.

### BACKGROUND

This invention relates generally to online marketing, and more specifically, to online word-of-mouth marketing of a web service using personalized invitations sent via a status messaging service, such as those offered by a social network system.

The goal of a typical marketing campaign is to introduce products or services to potential consumers. Marketers may use a variety of channels to market to potential consumers. In online marketing, for example, word-of-mouth (WOM) marketing may involve methods that exploit preexisting social networks to spread a marketing message. In advertising, the term “viral” is often used interchangeably with WOM, although each connotes a different emphasis. The former is based on an analogy with the growth dynamics of epidemics caused by viral infection, while the latter originates in the observed efficacy of product endorsements between friends. Accordingly, these concepts are interwoven because a marketing message propagates virally if people pass it along to their friends. For simplicity, the term WOM is used herein to describe all marketing methods of this nature.

The growth of the Internet has created new marketing paradigms and revolutionized advertising technology. By creating novel ways for people to communicate and influence each other, the Internet is a particularly powerful mechanism for WOM campaigns. As users become savvier about banner and search engine advertising, WOM channels assume greater importance to the online advertising industry.

Many website owners and web application providers seek to increase their total number of registered users or user accounts. The initial advertising campaign of Hotmail, a free web email client, exemplifies a WOM marketing strategy designed for this purpose. Hotmail would insert a promotional line at the bottom of every email message that included hypertext linked to a registration page for new users. Because the line was positioned near the sender's digital signature, users were tacitly endorsing Hotmail to their friends and colleagues each time they sent an email message. However, this promotional line was still a message from the email service, and not the individual, so it carried less weight.

Although email and instant messaging (IM) clients have long enabled efficient online person-to-person communication, more recently social network sites (SNSs) have emerged that create new modes of online socializing. In a social network, users are offered ways to define their connections in the social network, and they are given a personal web page that can be customized with content and functionality of various forms, accessible publicly or by invitation. Since their introduction, SNSs have attracted millions of daily users, and most now provide application programming interfaces that allow third party applications to interoperate with the SNS and its repository of user data. This development has substantially diversified the content and functionality available to users of these sites.

Rapid growth in the number of SNS users has been assisted by WOM invitation systems. For example, when a new SNS account is opened, the new user may be asked to select a third party web application that stores personal contacts (such as an email application), and the user may be prompted to enter the login information associated with that third party web application. Using this information, the SNS imports the contact data from the third party web application. In one example, a graphical user interface is displayed enabling the user to select the contacts who will receive an invitation. Once the user selects contacts to invite, a personalized invitation message from the new user to each selected contact is generated that asks the recipient to create an account with the SNS.

Applications operating on an SNS platform frequently use a similar invitation system, but where the user's contacts are taken directly from the SNS database and the invitation is sent over the SNS's internal messaging system. Once established, users may continue to receive direct messaging generated by the SNS or SNS applications for various purposes. These messages can be used for WOM marketing, since they can be directed to other users who are connected to a given user in a social network.

A problem with these types of direct invitation messages, however, is that they may be perceived as spam by the recipient. Spam refers to unsolicited electronic messages promoting a product or service. Spam sent through email is a problem for users because it can be difficult and time consuming to sort wanted from unwanted messages. It is also problematic for marketers because, like other forms of direct marketing, spam can contribute to negative perceptions of a product or service. In addition, most email clients now employ sophisticated algorithms devoted to spam recognition and filtering, so spam often does not even reach the intended recipient. Spam originating from SNSs and SNS applications has been a problem because it can diminish the user's experience with the SNS. SNSs have responded to this problem by limiting their own direct messaging to their members and by placing various restrictions on direct messaging from third party SNS applications.

Nevertheless, direct messaging by marketers on the Internet remains a flawed channel for WOM marketing because it can be perceived as spam. Although this applies to SNS and SNS application messaging, it applies equally to any online WOM marketing campaign that uses direct messaging, since any message sent by a website or web application directly to a user, through email or otherwise, could potentially be perceived as spam. Therefore, it is desirable to develop new methods of WOM marketing that can be used on the Internet without these drawbacks.

### SUMMARY

Embodiments of the invention provide an online channel for indirect messaging suitable for WOM marketing campaigns. In one embodiment, a user of a web service, such as a website or a web application, is prompted to endorse the web service to the user's friends or other connections. More specifically, the user is prompted to endorse the web service via a status message submitted to one or more status messaging services to which the user belongs. The status messaging service may be part of a social network. A status message is generated that contains an endorsement of the web service, and the status message may further contain a link (such as a hyperlink or URL) to a personal invitation page for the web service. By submitting the status message to one or more status messaging services, the endorsement contained therein is then communicated to the user's connections in each of the status messaging services. Since the status message is not sent directly from the web service being endorsed, this indirect endorsement from the user will have a greater influence on the recipients as compared to a direct marketing message. The web service may also automatically submit a status message containing an endorsement to one or more user-selected status messaging services when certain user actions are performed in connection with the web service.

### BRIEF DESCRIPTION OF THE DRAWINGS

FIG. 1 is a block diagram of a system for word-of-mouth marketing using personalized invitations in a status messaging service, in accordance with an embodiment of the invention.

FIG. 2 is an interaction diagram of a process for word-of-mouth marketing using personalized invitations in a status messaging service, in accordance with an embodiment of the invention.

FIG. 3 is an example graphical user interface for prompting a user to endorse a web service via the user's status messaging services, in accordance with an embodiment of the invention.

FIG. 4 is an example personal invitation page, in accordance with an embodiment of the invention.

FIGS. 5-7 are example status message lists from different status messaging services, each status message list including a status message endorsement, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Embodiments of the invention enable indirect marketing of a web service to a user's connections by sending a personalized endorsement of the web service in a status message for the user, which may then be received by those connections. This marketing may be more effective because the endorsement is in the voice of the user, who is also connected in some way to the recipient of the message. This is compared to direct messages sent by or on behalf of the web service being marketed, as that kind of marketing by direct messaging is less personal and may be perceived as spam by the recipient.

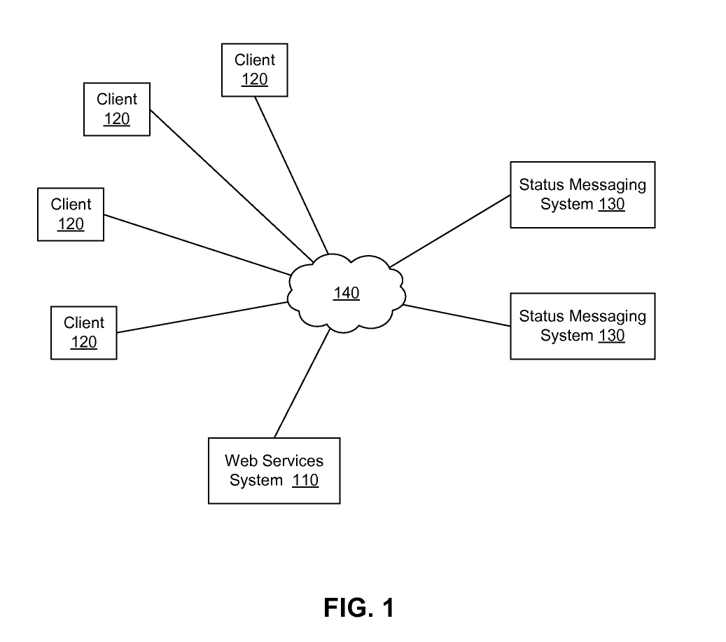

FIG. 1 illustrates an example of a network system for marketing a web service in accordance with embodiments of the invention. In this network system, a web services system 110 is coupled to a network 140, such as the Internet or any other appropriate communications network, or combinations thereof. The web services system 110 may comprise a computing device, such as a server, that provides web services to one or more users. The users may be registered with the web services system 110, which may also keep a database of each user's account information, such as login information, preferences, and any other data about the users that may be relevant to providing web services to the user. Although only one web services system 110 is shown, any number of web services systems may exist in any combination to provide one or more web services to users.

In one embodiment, the web services system 110 comprises a web server that operates a website that provides web services to the users. The website may comprise a set of linked web pages generally corresponding to a particular domain name, managed as a single entity and deliverable to a client device through a web browser. In another embodiment, the web services system 110 comprises an application server, which provides functionalities for a web application. In this context, a web application may comprise software program that is accessed over a network and designed to be used on a website through a web browser. Alternatively, a web application may run on a local client device (such as a personal computer or a portable communication device) and communicate with the web services system 110 over a network to obtain information processed by the application. A mapping program on a portable device is an example of such a web application. It can thus be appreciated that a variety of web services can be provided by the web services system 110 within the context of embodiments of the invention.

Users may communicate with the web services system 110 using a local client 120. The client 120 comprises a computing system and a network interface capable of communicating over the network 140. In various embodiments, the client 120 may be a personal computer, a portable communication device, or any other computing system capable of communicating with the web services system 110 to provide web services to the user. A user of the web services may be a person who has access to a website or web application through a registered account stored on the website or web application servers. Users are typically identified by a user name and password.

The network system also comprises one or more status messaging systems 130. Each status messaging system 130 provides status messaging services to one or more of the users. The concept of status messaging has emerged recently in connection with social applications on the Internet. In general, status messaging services are designed to allow users to view brief, timely messages from friends at a glance and, conversely, to send these messages to their connections in a social network. Typically, a status message, often consisting of less than a predetermined number of characters (e.g., 300), communicates something about a person's activities, opinions or status. Although called a status message, this term does not require that the content of the status message actually describe the user's status. Rather, the status message may comprise a posting or any other communication from the user to the user's connections in the status messaging service. It is noted that some status messaging systems 130 also enable the public (i.e., people outside a user's social network) to search for and access a user's status messages.

In one embodiment, a status messaging system 130 maintains an account for each of a number of users. Users may subscribe to or otherwise connect with the accounts of other users, and these connections may be in one direction or in both directions. The status messaging system 130 enables a user to provide a status message, which may contain text, links, pictures, and/or any other type of suitable content. When a user provides a status message to the status messaging system 130, the status message may then be communicated to the other users of the status messaging service who have connected to the user to receive that user's status messages. As used herein, the other users who have signed up with the status messaging system 130 to receive a particular user's status messages are part of that user's social network. Accordingly, a status message is submitted by a particular user to a status messaging system 130 for the purpose of being displayed on the status message lists of one or more other users in that user's social network.

In some embodiments, the status messaging system 130 displays a status message list to its users. A status message list is typically personalized for a user, comprising status messages from the other users in that user's social network. Typically, the status message list includes for each status message an identifier of the user who provided the status message alongside the corresponding status message. A status message list may display status messages ranked by how recently the status message was submitted, by relevancy to the user, or a combination of the two. The status message list may also be limited to a number of status messages, so that status messages too low on the list are not displayed.

The status messaging system 130 may provide status messaging services in a variety of different contexts. These include, but are not limited to, social networking websites (such as MySpace or Facebook), instant messaging (IM) clients (such as Google Talk), and microblogging services (such as Twitter). The status messaging system 130 thus provides a communication channel that allows an endorsement to be made in a status message from a user, which enables WOM marketing to a user's social network. Such an endorsement is unlikely to be perceived as spam because status messaging is inherently indirect and because status message lists typically do not require sorting or deleting (unlike email). In this sense, status messages provide a useful vehicle for WOM marketing.

In one embodiment, the web services system 110 and the status messaging system 130 are in different domains. In another embodiment, the web services system 110 is in the same domain, or at least provides the web services via the same domain, as one or more of the status messaging systems 130. For example, the web services system 110 may comprise a platform application in a social network that also provides status messaging services. In this example, the web services and status messaging services are both provided in the domain of a social networking website.

A user may use one or more of the status messaging services. In this context, use of a status messaging service may involve sending status messages to others, receiving status messages from others, or both. In addition to using a status messaging service, a user may or may not be a user of the web services. In certain embodiments of the invention, it is contemplated that at least some of the users of the status messaging services are not already users of the web services, since the status messaging services are used by the web services to invite these users to join the web services.

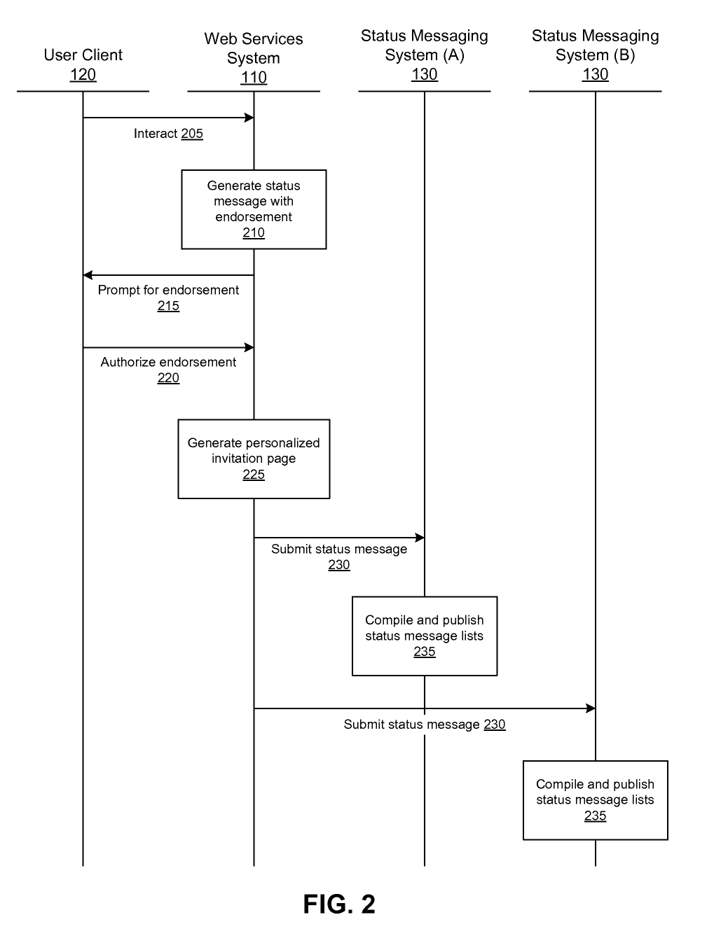

FIG. 2 illustrates a process for WOM marketing using embodiments of the network system described in FIG. 1. This process comprises a series of steps, which may proceed by means of client-server communication over the computer network 140. The process may begin with a user using a client 120 to interact 205 with the web services system 110. As the web services offered by the web services system 110 may vary, so can this interaction. For example, the interaction may comprise the user's signing up with or logging into the web services system 110. Alternatively, the interaction may comprise a use of the web services offered by the web services system 110.

In addition to providing any request web services, the web services system 110 may generate 220 a sample status message containing an endorsement and prompt 210 the user to send the endorsement of the web services. This prompt may be sent as an electronic communication from the web services system, such as an email or a web page delivered to the user's client 120. In one embodiment, the prompt requests authorization for the web services system 110 to submit a new status message on the user's behalf to one or more status messaging systems 130. The prompt may also request information to enable the web services system 110 to submit status messages on the user's behalf, such as long information for the selected status messaging systems 130. In another embodiment, the prompt merely contains a copy of the intended endorsement message and instructions for the user to submit the endorsement manually (e.g., by copying and pasting) as a new status message in one or more of the user's status messaging services.

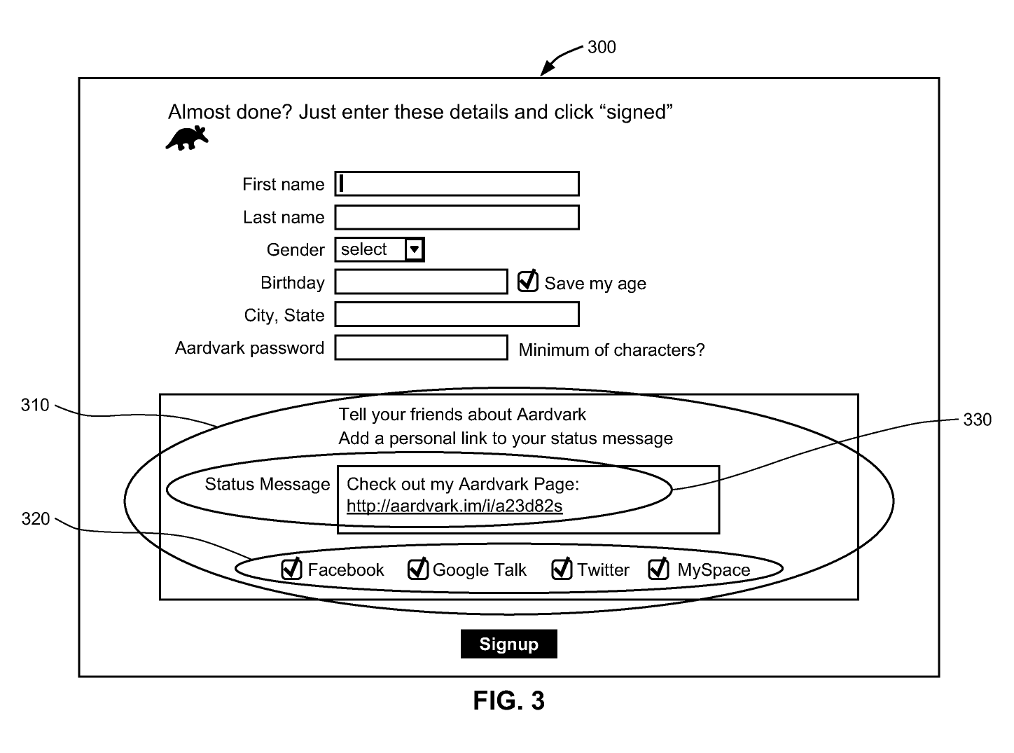

FIG. 3 illustrates a web page containing a prompt to a user to endorse the web services. The web page provides a graphical user interface (GUI) allowing the user to select from a number of options for endorsing the web services. In this example, as a user is signing up for a web service called “Aardvark,” the user is prompted to endorse the web service in the user's status messages. The prompt is provided as a web page 300 transmitted to the client 120 from the web services system 110. The web page 300 contains a GUI for providing information to the user and for receiving information from the user.

In addition to user interface elements for receiving information to sign up to the web service, the web page 300 includes a prompt 310 requesting the user to endorse the web service in one or more status messaging services to which the user might belong. In this example, the prompt 310 comprises a status message field 330 that allows the user to specify the content of the status message. In one embodiment, the status message field 330 is pre-populated with an endorsement, which comprises text inviting the user's friends to use the endorsed web services. The pre-populated status message may also comprise a link to a web page associated with the web services. The status message field 330 may allow the user to edit the default status message endorsement, or it may be fixed so that the user cannot edit it. The prompt 310 also comprises a list 320 of status messaging services from which the user can select to authorize the web services system 110 to submit a status message on behalf of the user to the corresponding status messaging systems 130. When the user selects one or more status messaging services from the list 320, the user may be prompted further to enter the user's login information for each of the selected status messaging services. Alternatively, the prompt 310 may be associated with a single status messaging service, in which case there would be no need for the user to select one.

In response to the prompting 215 by the web services system 110, the user may direct the client 120 to send a message to authorize 220 the web services system 110 to endorse the web services on the user's behalf. In the example prompt interface of FIG. 3, the user may authorize 220 the endorsement by selecting one or more status messaging services to which the user belongs and then providing login information for each selected status messaging service.

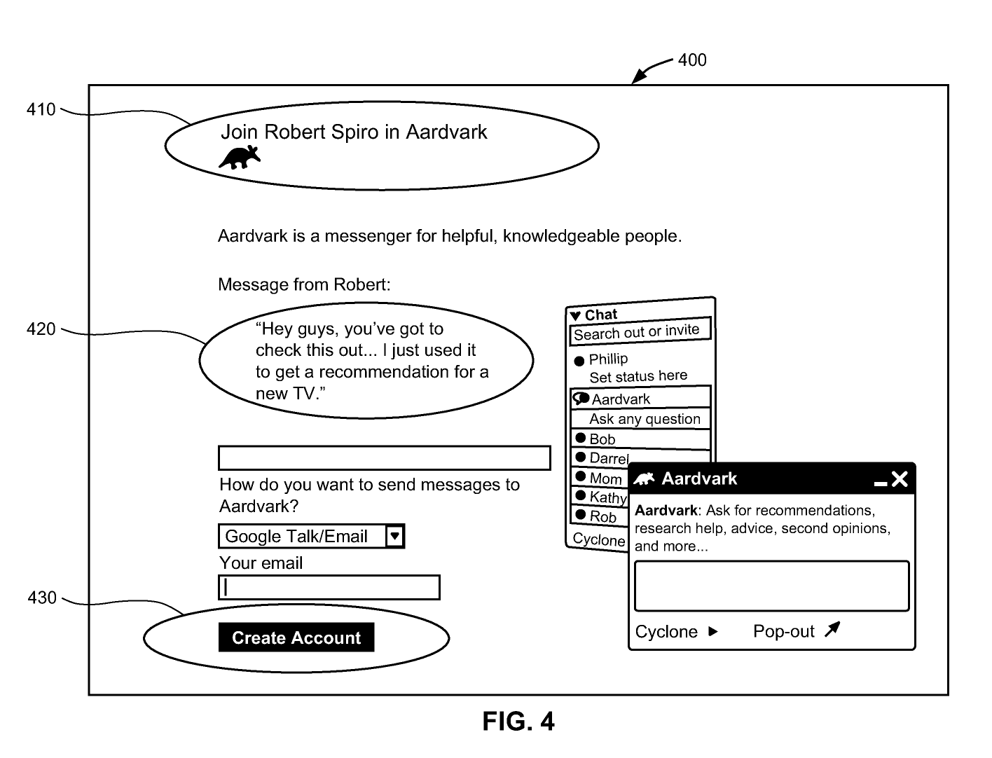

Continuing the example from FIG. 3, where the endorsement includes a link to a personalized invitation page for the web services, the web services system 110 generates 225 the personalized invitation web page. This personalized web page may include content from the status message that the user authorized 220, and it may otherwise contain information specific to the user who is making the endorsement. FIG. 4 illustrates an example of a personalized invitation page 400 that would be provided in response to selecting the link in the user's status message endorsement. In this example, the personalized invitation page 400 includes a field 410 containing the name of the endorsing user, a message field 420 containing a personalized message from the endorsing user, and an interface 430 (e.g., a button or link) for creating a new account with the endorsed web services. Alternatively, the link in the status message endorsement may be for a generic web page associated with the web services, where the web page may allow new users to sign up for the web services, download a web application, or otherwise provide information and/or content for using the web services being endorsed.

Once the user has authorized the web services system 110 to endorse the web services on the user's behalf via one or more status messaging services to which the user belongs, the web services system submits 230 the status messages to each corresponding status messaging system 130. In one embodiment, the web services system 110 uses login information provided by the user to log into each status messaging system 130 and then submits 230 the status message just as a user might do. Once this is completed, therefore, the status messaging systems 130 treat the submitted status messages and the endorsements contained therein just as they would any other status message submitted by the user. Accordingly, each status messaging system 130 compiles and publishes status message lists to the other users of the status messaging systems 130, where the status message endorsement is contained in one or more of these status message lists. In this way, the endorsement in the status message is communicated to other users who use the status messaging services to see information about the endorsing user.

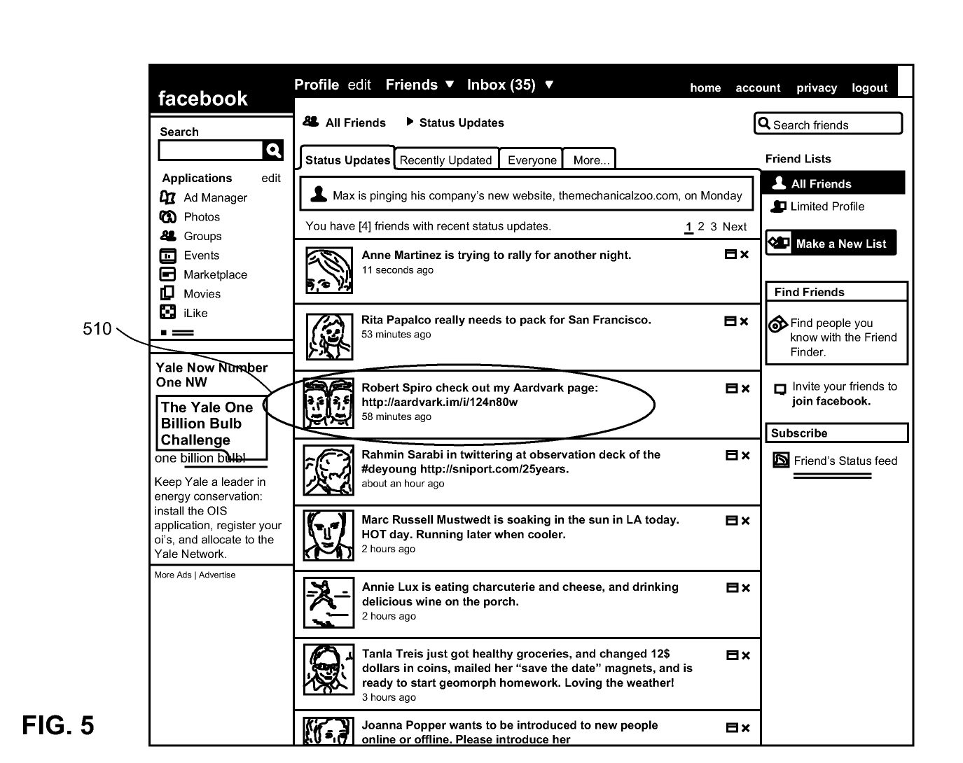

The way the status message endorsement is ultimately viewed by others depends on the type and design of the status messaging system 130 to which the status message endorsement is submitted. As explained above, a status messaging system 130 often compiles multiple status messages into a status message list and displays the status message list to a user. The status messages in a status message list for a particular user may contain, for example, a set of status messages submitted by other users to whom that user is connected in the status messaging system 130. Examples of different status messaging services that may display a status message list containing the status message endorsement are shown in FIGS. 5-7.

The examples shown in FIGS. 5-7 are provided for illustration only, and it can be appreciated that any number of status messaging formats and presentations can be used to publish the personalized WOM marketing endorsements created by embodiments of the invention. These status messaging systems 130 represent an indirect communication channel that is distinct from established Internet messaging channels such as email, IM, and blogging, and may be implemented on a diverse array of websites and applications. Often, status messaging systems 130 are deployed in connection with a website or web application that stores users' social networks for other purposes.

The example shown in FIG. 5 illustrates a status message list in an embodiment where the status messaging system 130 is part of a social networking website. This example shows a web page of the social networking website that contains a status message list created for a friend of the endorsing user. The status message list includes the status message endorsement 510. The status message list may also include items other than status messages, such as other content posted by a user and/or advertisements. In addition, the user may see the friend's status message (and the endorsement therein) in other web pages provided by the social networking website. For example, a social networking website may provide a personal web page for each of its users, and the personal web page for the friend who made the endorsement may include the friend's status message that contains the endorsement.

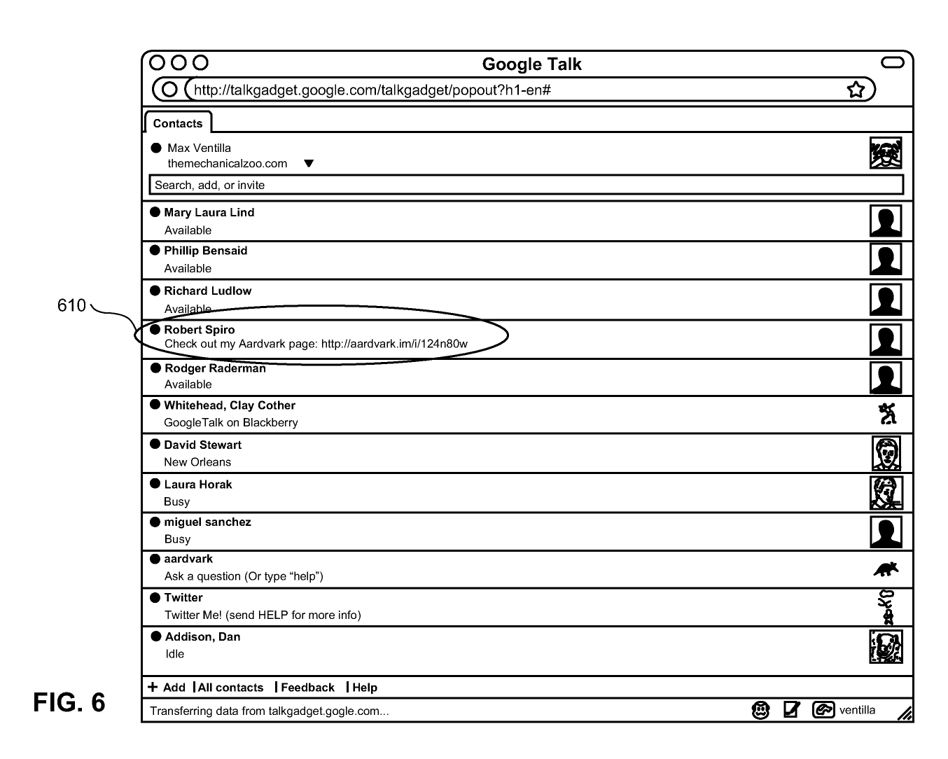

Instant messaging is another example of service that may include a status messaging system 130 and provide an interface in which a list of one's friend's status messages may be presented. FIG. 6 shows an IM client window, which may be provided in a web page interface or in a client application. The IM client window shows a list of other users with whom the user has established a connection. The list of users also displays the status message of any users who have chosen to provide a status message. Accordingly, the WOM marketing techniques described herein may be used to place an endorsement in a user's status message so that the user's friends will see the endorsement in their IM client window. As shown in FIG. 6, the IM client window of a friend of the endorsing user shows the status message 610 that endorses the web services.

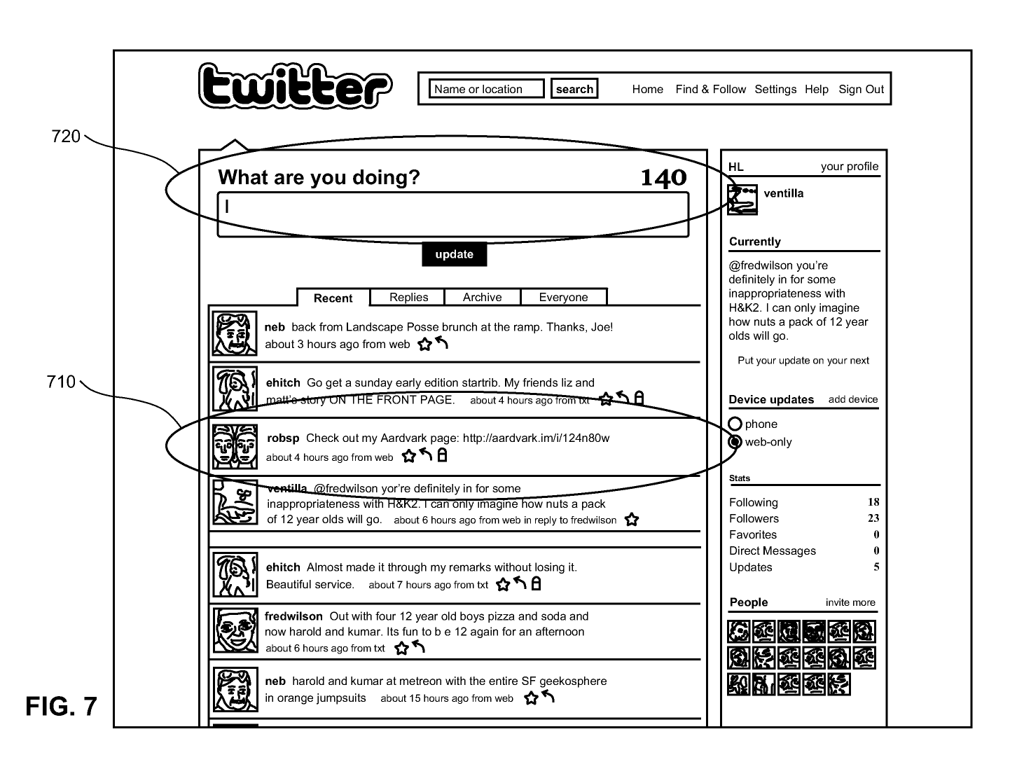

FIG. 7 shows yet another example of a status messaging system 130 that may display the status message endorsement. In this example, users can subscribe to the status messages of other users, and users can post their own status messages so that they will be seen by users who are subscribed to their status messages. The interface shown in FIG. 7 provides a list of status messages, where one of the status messages 710 contains an endorsement in accordance with the embodiments described herein. The interface also provides a message field allowing the user to post new status messages to be seen by to others. In this example, the question, “What are you doing?” precedes the status message field 720, thereby illustrating the personal and transitory aspect of status messaging.

In another embodiment, a user may preauthorize the web services system 110 to submit new status messages to the one or more status messaging systems 130 automatically. This preauthorization may be done via a user interface similar to the one shown in FIG. 3. In this way, the web services system 110 may submit new status messages to endorse the corresponding web services without requiring the user to authorize the endorsement each time one is made. In this way, the web services system 110 can send endorsements via the user's status messaging services each time the user has engaged in certain interactions with the web services system 110. For example, each time a user logs into a web services system 110, the system 110 may update the user's status with a message that indicates that the user is using the services (e.g., “Max is currently using Aardvark”), along with an optional link enabling others to access the same web services more easily.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. It is noted that in the embodiments described herein software is not a mere abstraction. Rather, embodiments of the invention implemented in software comprise instructions that are functionally and tangibly embodied on a storage medium and usable to control a machine, such as a computer system, to perform the processes described herein.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or a tangible carrier wave and modulated or otherwise encoded and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for online marketing of a web service, the method comprising:
observing an interaction with a web service by a user over a computer network;
prompting the user to endorse the web service via a status message in one or more status messaging services of which the user is a member;
receiving authorization from the user to endorse the web service, the authorization identifying one or more status messaging services of which the user is a member; and
communicating with the identified status messaging services to submit a status message for the user in the identified status messaging services, the submitted status message comprising an endorsement by the user of the web service;
wherein the submitted status message is communicated to one or more of the user's connections within a communication channel of the identified status messaging services.

2. The method of claim 1, wherein the observed interaction comprises the user's signing up with the web service.

3. The method of claim 1, wherein the observed interaction comprises the user's logging into the web service.

4. The method of claim 1, wherein the observed interaction comprises the use of the web service by the user.

5. The method of claim 1, wherein prompting the user comprises sending a web page to the user, the web page containing a graphical user interface for requesting the user to endorse the web service and one or more options for the user to authorize the web service to submit a status message to one or more status messaging services on the user's behalf.

6. The method of claim 1, wherein prompting the user comprises communicating a default endorsement for submission in the status message.

7. The method of claim 6, wherein the default endorsement is editable by the user in a user interface.

8. The method of claim 1, wherein the authorization identifies multiple status messaging services of which the user is a member.

9. The method of claim 1, wherein the authorization includes the user's login information for one or more of the identified status messaging services.

10. The method of claim 9, wherein communicating with the identified status messaging services to submit a status message comprises logging into the identified status messaging services and submitting the status message therein using the user's account.

11. The method of claim 1, wherein the submitted status message further comprises a link to a web page associated with the endorsed web service.

12. The method of claim 11, wherein the link is for a personalized invitation page, the personalized invitation page containing a user interface that identifies the user and includes options for creating a new account with the web service.

13. The method of claim 1, wherein the submitted status message further comprises a link to a web page associated with the endorsed web service.

14. The method of claim 1, wherein the web service is a website.

15. The method of claim 1, wherein the web service is a web application.

16. The method of claim 1, wherein the authorization from the user is received as a preauthorization before the interaction with the web service is observed, and wherein the status message is submitted to the identified status messaging services responsive to observing the interaction with the web service.

17. The method of claim 1, wherein the web service is offered on a different domain than the identified status messaging services.

18. A method for online marketing of a web service, the method comprising:
observing an interaction with a web service by a user over a computer network;
generating a status message comprising an endorsement by the user of the web service;
prompting the user to endorse the web service by submitting the generated status message in one or more status messaging services of which the user is a member, wherein the web service is offered on a different domain than the identified status messaging services; and
communicating the generated status message via a computer network for submission in one or more status messaging services of which the user is a member.

19. The method of claim 18, wherein the generated status message is communicated to the user for manual submission in one or more status messaging services of which the user is a member.

20. The method of claim 18, wherein the generated status message is communicated directly to one or more status messaging services of which the user is a member.

21. A computer program product for online marketing of a web service, the computer program product comprising a computer-readable storage medium containing computer program code for:
observing an interaction with web service by a user over a computer network;
prompting the user to endorse the web service via a status message in one or more status messaging services of which the user is a member;
receiving authorization from the user to endorse the web service, the authorization identifying one or more status messaging services of which the user is a member; and
message for the user in the identified status messaging services, the submitted status message comprising an endorsement by the user of the web service.

22. The computer program product of claim 21, wherein the observed interaction comprises at least one of the user's signing up with the web service and the user's logging into the web service.

23. The computer program product of claim 21, wherein prompting the user comprises sending a web page to the user, the web page containing a graphical user interface that:
requesting the user to endorse the web service;
communicates a default endorsement for submission in the status message;
contains one or more options for the user to specify one or more status messaging services in which to submit the status message; and
contains one or more options for the user to authorize the web service to submit a status message to one or more status messaging services on the user's behalf.

24. The computer program product of claim 21, wherein the authorization includes the user's login information for one or more of the identified status messaging services, and wherein communicating with the identified status messaging services to submit a status message comprises logging into the identified status messaging services and submitting the status message therein using the user's account.

25. The computer program product of claim 21, wherein the submitted status message further comprises a link to a web page associated with the endorsed web service, and wherein the link is for a personalized invitation page, the personalized invitation page containing a user interface that identifies the user and includes options for creating a new account with the web service.

26. The computer program product of claim 21, wherein the web service is offered on a different domain than the identified status messaging services.
